(19) United States
(12) Patent Application Publication
(10) Pub. No.: US 2006/0058449 A1
(43) Pub. Date: Mar. 16, 2006

(54) Vinyllactam copolymers used as gas hydrate inhibitors

(75) Inventors: Maximilian Angel, Schifferstadt (DE); Karin Neubecker, Frankenthal (DE); Stefan Stein, Worrstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/532,828

(22) PCT Filed: Oct. 28, 2003
(86) PCT No.: PCT/EP03/11928

§ 371 Date: Apr. 26, 2005

(30) Foreign Application Priority Data
Nov. 6, 2002 (DE) 102 52 010.0

(51) Int. Cl. C08F 8/30

(52) U.S. Cl. 524/555

(57) ABSTRACT

The invention relates to the use of copolymers as gas hydrate inhibitors, whereby these copolymers are synthesized from: 40 to 99.5% by weight of at least one ethylenically unsaturated cyclic lactam A; 0.5 to 60% by weight of monomers B having a solubility in water of less than 10 parts by weight of monomers in 100 parts by weight of water, and; 0 to 50% by weight of other monomers C.

The invention relates to the use of copolymers composed of

from 40 to 99.5% by weight of at least one ethylenically unsaturated lactam A

from 0.5 to 60% by weight of monomers B having a water solubility of less than 10 parts by weight of-monomer in 100 parts by weight of water and

from 0 to 50% by weight of other monomers C

as gas hydrate inhibitors.

It is known that gas hydrates, also known as clathrate hydrates, can form under certain conditions in media which comprise gas molecules such as CO₂ or hydrocarbons, e.g. C₁-C₄-alkanes, and water. These gas hydrates consist of the gas molecules mentioned which are surrounded by a “cage” of water molecules. Such gas hydrates also occur in water-containing mineral oil or natural gas mixtures and can thus lead to blockage of the pipelines, for example, in the course of transport.

In order to prevent this, gas hydrate inhibitors are added to the mineral oil or natural gas mixtures.

WO 94/12 761, WO 95/32 356 and DE 19935063 disclose polymeric additives for the prevention of clathrate hydrates in liquid systems which have a comonomer having a lactam ring in the polymer.

DE-A-10010811 discloses the use of homo- and copolymers in solvents having a high flashpoint as gas hydrate inhibitors. EP-A-795567 discloses copolymers of vinyllactams having hydrophobic monomers.

There is a need for improved gas hydrate inhibitors which are simultaneously very easy to prepare and thus inexpensive.

In particular, the gas hydrate inhibitors should prevent the formation of gas hydrates even at very low temperatures.

It is an object of the present invention to provide suitable polymers for use as a gas hydrate inhibitor, which satisfy the requirements to a very high degree.

Accordingly, the use defined at the outset has been found.

Monomers A are present in the copolymer preferably to an extent of at least 60% by weight, more preferably to an extent of at least 70% by weight; their proportion is preferably a maximum of up to 99% by weight, more preferably up to 95% by weight.

The proportion of monomers B is preferably at least 5% by weight, more preferably at least 10% by weight, but preferably does not exceed 40% by weight, in particular 30% by weight.

It is not necessary to also use monomers C in the context of the invention; the proportion of monomers C is therefore, for example, below 20% by weight, below 10% by weight and in particular 0% by weight.

The copolymer used as a gas hydrate inhibitor is, for example, preferably composed overall of

from 60 to 99% by weight of A,

from 1 to 40% by weight of B and

from 0 to 39% by weight of C.

It is more preferably composed of

from 70 to 90% by weight of A,

from 10 to 30% by weight of B and

from 0 to 20% by weight of C

and most preferably of

from 78 to 88% by weight of A and

from 12 to 22% by weight of B.

The monomers A are cyclic or noncyclic lactams, or vinyllactams. 40 Noncyclic vinyllactams include N-vinylamides, in particular N-vinyl-N-methylacetamide.

Monomers A are preferably cyclic lactams, in particular N-vinylcaprolactam or N-vinylpyrrolidone or mixtures thereof.

They are more preferably N-vinylpyrrolidone.

Monomers B are monomers, other than monomers A, having a solubility in water of less than 10 parts by weight, preferably less than 5 parts by weight, more preferably less than 1 part by weight, most preferably of less than 0.1 part by weight and in particular of less than 0.05 part by weight in 100 parts by weight of water at 21° C.

Monomers having corresponding solubility are in particular selected from C₁- to C₂₀-alkyl (meth)acrylates, C₁-C₂₀-alkyl(meth)acrylamides, e.g. t-butylacrylamide, vinyl esters of carboxylic acids containing up to 20 carbon atoms, styrenics having up to 20 carbon atoms, ethylenically unsaturated nitriles, vinyl halides, vinyl ethers of alcohols containing from 1 to 10 carbon atoms, aliphatic hydrocarbons having from 2 to 8 carbon atoms and one or two double bonds, or mixtures of these monomers.

The monomers are more preferably selected from: C₁-C₂₀-alkyl (meth)acrylates or vinyl esters of carboxylic acids having up to 20 carbon atoms.

They are even more preferably C₁- to C₈-alkyl acrylates or C₁- to C₈-alkyl methacrylates, in particular C₂-C₈-alkyl (meth)acrylates and more preferably C₄-C₈-alkyl (meth)acrylates, in particular n-butyl acrylate or 2-ethylhexyl acrylate.

Useful monomers C other than monomers A and B are any other monomers, for example also monomers having functional groups, for example carboxylic acid, hydroxyl or amino groups. Examples include hydroxy (meth)acrylates, (meth)acrylamide, (meth)acrylonitrile or (meth)acrylic acid or acrylamidomethylpropanesulfonic acid or salts thereof.

Preference is given to using the copolymers in the form of the solution or dispersion thereof.

Useful solvents include water, polar organic solvents such as alcohols, carboxylic esters or nonpolar solvents such as aliphatic or aromatic hydrocarbons.

Preference is given to solvents having a flashpoint greater than 50° C., more preferably greater than 61° C. and most preferably greater than 100° C.

The flashpoint is determined to DIN EN 22719.

Solvents having a flashpoint greater than 61° C. or greater than 100° C. are, for example, 1,2-ethanediol (111° C.) and 1,2-propanediol (107° C.).

The K value of the copolymer is preferably from 10 to 100, more preferably from 10 to 45 and even more preferably from 15 to 40 and in particular from 22 to 37 (measured on a solution having 5 parts by weight of copolymer to 100 parts by. weight of ethanol at 21° C.).

The copolymer can be prepared by customary methods of free-radical polymerization.

Examples include emulsion polymerization or solution polymerization.

The polymerization may be carried out in the presence of customary free-radical initiators such as peroxides or azo compounds (amount, for example, from 0.1 to 10% by weight based on the monomers) in a solvent, if appropriate under pressure, at temperatures between 50 and 160° C. The presence of substances which regulate the polymerization may also be advantageous. The monomers may preferably be fed in a feed process during the polymerization. In the case of very greatly differing reactivities of the monomers, possible methods also include a staged method, gradient method or feed rate controlled separately for each monomer.

The solids contents of the resulting solutions or dispersions are generally from 10 to 65% by weight, preferably from 25 to 45% by weight.

In a particular embodiment, the copolymer is prepared directly in a solvent having a high flashpoint, so that the abovementioned, preferably used solutions are obtained immediately in the course of preparation.

In such a preparation process, it may be necessary to dissolve and use individual additives, for example the initiator, in another solvent having a lower flashpoint than desired. Such solvents may be removed later, for example by distillation.

A corresponding process is described, for example, in DE 10010811.

The copolymers or the solutions or dispersions thereof are used as gas hydrate inhibitors.

It is possible for this use to add further additives to the solutions or dispersions.

Examples include further solvents, corrosion inhibitors, viscosity regulators, stabilizers,.other gas hydrate inhibitors, assistants for preventing agglomerations, for example antiagglomerates.

The copolymers or the solutions or dispersions thereof are especially suitable for mineral oil or natural gas; they are notable for high effectiveness as a gas hydrate inhibitor even at low temperatures and at small amounts used.

### EXAMPLES

Polymers used
polyvinylpyrrolidone, dissolved in water, solids content 30% by weight
polyvinylcaprolactam, dissolved in ethylene glycol, solids content 40% by weight
copolymer of 80% by weight of vinylpyrrolidone, 20% by weight of n-butyl acrylate, 40% by weight solution in ethylene glycol

Preparation of the Copolymer:

| | | | | Conc. | phm |
|---|---|---|---|---|---|
| Initial | 1080.00 | g | of ethylene glycol | 100.00% | 54.82 |
| charge | | | | | |
| | 200.00 | g | of isopropanol | 100.00% | 10.15 |
| | 40.00 | g | of vinylpyrrolidone | 100.00% | 2.03 |
| | 120.00 | g | of feed 1 | | |
| Feed 01 | 800.00 | g | of ethylene glycol | 100.00% | 40.61 |
| | 1530.00 | g | of vinylpyrrolidone | 100.00% | 77.66 |
| | 400.00 | g | of n-butyl acrylate | 100.00% | 20.30 |
| Feed 02 | 200.00 | g | of isopropanol | 100.00% | 10.15 |
| | 40.00 | g | of tert-butyl | 98.00% | 1.99 |
| | | | peroxy-ethylhexanoate | | |
| | 200.00 | g | of ethylene glycol | 100.00% | 10.15 |

The initial charge is heated to internal temperature 85° C. 5 g of feed 2 are then added at 80° C. and the mixture is polymerized for 3-5 minutes. Afterward, feed 1 within 5 hours and feed 2 within 6.5 hours are metered in. On completion of the addition of feed 2, polymerization is continued for another 3 hours. Volatile fractions are removed by vacuum distillation. Solids content 49.2% by weight.

The K values of the polymers are reported in the table; they are determined on a 5% by weight polymer solution in ethanol.

Use as a gas hydrate inhibitor

The suitability of the polymers as a gas hydrate inhibitor is determined from the initial freezing temperature of mixtures which comprise the polymers.

The “initial freezing temperature” was measured by the “ball-stop method” analogously to the test method described in Example 1 of WO 95/32356.

This method relates to initial freezing points to be tested of water/THF mixtures by addition of different polymers (proof of hydrate formation) which have been frozen in a 0.5% concentration in a water/THF (81/19% by weight) mixture.

To determine the initial freezing point of various polymer/(water/THF) mixtures, the following equipment and reagents are needed:
water/THF mixture (81/19% by weight)
thermostat bath with water/ethylene glycol (5/1) refrigerant mixture
constant stirrer
holder for test tubes (5 ml)
small stainless steel balls for better mixing in the test tube

A 0.5% solution of the polymer to be investigated is prepared in water/THF (81/19). The test tube is ⅔ filled, provided with a small stainless steel ball, sealed and secured in the test tube holder. The measurement is started at bath temperature 4° C. and a rotation rate of 20 rpm and the temperature is reduced by 0.5° C. per hour until the sample has started to freeze, i.e. the steel 45 balls no longer move in the test tube. A blank sample runs in parallel to each measurement.

The initial freezing temperature is specified in the table which follows. The lower the initial freezing temperature, the better the suitability as a gas hydrate inhibitor generally is.

| | | Initial freezing |
|---|---|---|
| Polymer | K value | temperature ° C. |
| None | — | 4.0 |
| Polyvinylpyrrolidone | 30 | 2.5 |
| Polyvinylcaprolactam | 26 | 0.5 |
| Inventive polymer | 30.6 | −1 |
| (80 VP 20 nBA) | | |

1-9. (canceled)

10. A method of preventing or reducing the formation of gas hydrates in a liquid or a gas comprising adding a solution or dispersion of copolymers composed of
from 40 to 99.5% by weight of at least one ethylenically unsaturated lactam A,
from 0.5 to 60% by weight of at least one C₄ to C₈ alkyl (meth)acrylate (monomer B) having a water solubility of less than 10 parts by weight of monomer in 100 parts by weight of water at 21° C., and
from 0 to 50% by weight of other monomers C
to solvents having a flashpoint greater than 50° C. forming a gas hydrate inhibitor and adding the gas hydrate inhibitor to a liquid or gas.

11. The method according to claim 10, wherein the copolymer is composed of
from 60 to 99% by weight of lactam A,
from 1 to 40% by weight of monomer B, and
from 0 to 39% by weight of monomer C.

12. The method according to claim 10, wherein the proportion of the monomers C is less than 5% by weight.

13. The method according to claim 10, wherein the lactam is N-vinylpyrrolidone.

14. The method according to claim 10, wherein the copolymer is prepared by solution polymerization in solvents having a flashpoint greater than 50° C.

15. The method according to claim 10, wherein the copolymer has a K value of from 10 to 100, measured in 5% by weight ethanol solution at 21° C.

16. A process for preventing or reducing the formation of gas hydrates in liquids or gases, comprising adding to these liquids or gases a copolymer or a solution thereof wherein the copolymer or the solution thereof comprises
from 40 to 99.5% by weight of at least one ethylenically unsaturated lactam A,
from 0.5 to 60% by weight of at least one C₄ to C₈ alkyl (meth)acrylate (monomer B) having a water solubility of less than 10 parts by weight of monomer in 100 parts by weight of water at 21° C., and
from 0 to 50% by weight of other monomers C.

17. The process according to claim 16, wherein the liquids or gases are mineral oil or natural gas.

18. A solution of copolymers which has a K value of from 10 to 45 in 5% by weight ethanol solution at 21° C. comprising,
from 40 to 99.5% by weight of at least one ethylenically unsaturated, cyclic lactam A,
from 0.5 to 60% by weight of monomer B, and
from 0 to 50% by weight of other monomers C
in solvents having a flashpoint greater than 50° C.

19. The method as claimed in claim 10, wherein the at least one ethylenically unsaturated lactam A is selected from the group consisting of cyclic lactams, noncyclic lactams, vinylactams, N-vinylamides, N-vinyl-N-methylacetamide, N-vinylcaprolactam, N-vinylpyrrolidone and mixtures thereof.

20. The method as claimed in claim 10, wherein monomer B is selected from the group consisting of n-butyl-acrylate, 2-ethylhexyl acrylate and mixtures thereof.

21. The method as claimed in claim 10, wherein monomer C is selected from the group consisting of hydroxy(meth)acrylates, (meth)acrylamide, (meth)acrylonitrile, (meth)acrylic acid or salts thereof, acrylamidomethylpropanesulfonic acid or salts thereof and mixtures thereof.

22. The process as claimed in claim 16 wherein the at least one ethylenically unsaturated lactam A is selected from the group consisting of cyclic lactams, noncyclic lactams, vinylactams, N-vinylamides, N-vinyl-N-methylacetamide, N-vinylcaprolactam, N-vinylpyrrolidone and mixtures thereof.

23. The process as claimed in claim 16, wherein monomer B is selected from the group consisting of n-butyl-acrylate, 2-ethylhexyl acrylate and mixtures thereof.

24. The process as claimed in claim 16, wherein monomer C is selected from the group consisting of hydroxy(meth)acrylates, (meth)acrylamide, (meth)acrylonitrile, (meth)acrylic acid or salts thereof, acrylamidomethylpropanesulfonic acid or salts thereof and mixtures thereof.

25. The solution as claimed in claim 18, wherein the at least one ethylenically unsaturated lactam A is selected from the group consisting of cyclic lactams, noncyclic lactams, vinylactams, N-vinylamides, N-vinyl-N-methylacetamide, N-vinylcaprolactam, N-vinylpyrrolidone and mixtures thereof.

26. The solution as claimed in claim 18, wherein monomer B is selected from the group consisting of n-butyl-acrylate, 2-ethylhexyl acrylate and mixtures thereof.

27. The solution as claimed in claim 18, wherein monomer C is selected from the group consisting of hydroxy(meth)acrylates, (meth)acrylamide, (meth)acrylonitrile, (meth)acrylic acid or salts thereof, acrylamidomethylpropanesulfonic acid or salts thereof and mixtures thereof.
